(19) United States
(12) Patent Application Publication
(10) Pub. No.: US 2026/0275950 A1
(43) Pub. Date: Sep. 17, 2026

(54) INTELLIGENT AUTOMATIC START/STOP FOR VEHICLE ENGINES

(71) Applicant: GM GLOBAL TECHNOLOGY OPERATIONS LLC, DETROIT, MI (US)

(72) Inventors: Tomer Pe'er, Petah Tikva (IL); Dan Levi, Ganei Tikvah (IL); Johnathon C. Cato, Highland, MI (US)

(21) Appl. No.: 19/076,310

(22) Filed: Mar. 11, 2025

(51) Int. Cl. F02N 11/08

(52) U.S. Cl. CPC F02N 11/0833; F02N 2200/101; F02N 2200/102; F02N 2200/123; F02N 2200/125

(57) ABSTRACT

Examples described herein provide a method for intelligent automatic start/stop for vehicle engines. The method includes receiving data from a sensor of a vehicle. The method further includes performing a perception task based at least in part on the data received from the sensor of the vehicle. The method further includes determining whether an internal combustion engine of the vehicle is stopped or started. The method further includes, responsive to determining that the internal combustion engine of the vehicle is stopped, determining whether to start the internal combustion engine based at least in part on the perception task. The method further includes, responsive to determining to start the internal combustion engine, starting the internal combustion engine.

### BACKGROUND

The subject disclosure relates to vehicles, and in particular to intelligent automatic start/stop for vehicle engines.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time and frequency change between emission and reception. The measured time can be used to determine the distance between the radar device and the detected object, while the measured frequency change in the carrier wave can be used to determine the speed difference using Doppler effect, which can be used when performing perception tasks.

Perception tasks can include one or more of object detection, classification, tracking, lane detection, road sign recognition, and obstacle avoidance. Perception tasks are particularly useful for an autonomous or semi-autonomous vehicle to provide the vehicle with real-time awareness of its environment to make safe and informed driving decisions. Images from the one or more cameras of the vehicle can also be used for detecting objects, tracking targets, and/or the like, including combinations and/or multiples thereof. Perception tasks are useful for implementing advanced driver assistance systems (ADASs), engine auto start/stop systems, and/or the like, including combinations and/or multiples thereof.

The desire for improving intelligent automatic start/stop for vehicle engines is important for efficient operation of the vehicle.

### SUMMARY

In one embodiment, a computer-implemented method for intelligent automatic start/stop for vehicle engines is provided. The method includes receiving data from a sensor of a vehicle. The method further includes performing a perception task based at least in part on the data received from the sensor of the vehicle. The method further includes determining whether an internal combustion engine of the vehicle is stopped or started. The method further includes, responsive to determining that the internal combustion engine of the vehicle is stopped, determining whether to start the internal combustion engine based at least in part on the perception task. The method further includes, responsive to determining to start the internal combustion engine, starting the internal combustion engine.

In addition to one or more of the features described herein, or as an alternative, further embodiments of the method may include, responsive to determining that the internal combustion engine of the vehicle is started, determining whether to stop the internal combustion engine based at least in part on the perception task.

In addition to one or more of the features described herein, or as an alternative, further embodiments of the method may include, responsive to determining to stop the internal combustion engine, stopping the internal combustion engine.

In addition to one or more of the features described herein, or as an alternative, further embodiments of the method may include that the sensor is a camera.

In addition to one or more of the features described herein, or as an alternative, further embodiments of the method may include that determining whether to start the internal combustion engine is further based at least in part on data about a start/stop condition of the vehicle.

In addition to one or more of the features described herein, or as an alternative, further embodiments of the method may include that determining whether to start the internal combustion engine is further based at least in part on data about an operator input for the vehicle.

In addition to one or more of the features described herein, or as an alternative, further embodiments of the method may include that determining whether to start the internal combustion engine is further based at least in part on data external to the vehicle.

In addition to one or more of the features described herein, or as an alternative, further embodiments of the method may include that the perception task detects at least one of: a traffic light change, a traffic sign, a road lane, and an ego position of the vehicle.

In addition to one or more of the features described herein, or as an alternative, further embodiments of the method may include that the perception task determines an amount of time until it is desired for the vehicle to move, wherein it is determined to start the internal combustion engine responsive to the amount of time being less than a threshold.

In another embodiment, a vehicle is provided. The vehicle includes a sensor, an internal combustion engine, and a processing system that includes a memory having computer readable instructions and a processing device for executing the computer readable instructions, the computer readable instructions controlling the processing system to perform operations for intelligent automatic start/stop for vehicle engines. The operations include receiving data from the sensor. The operations further include performing a perception task based at least in part on the data received from the sensor of the vehicle. The operations further include determining whether the internal combustion engine of the vehicle is stopped or started. The operations further include, responsive to determining that the internal combustion engine of the vehicle is started, determining whether to stop the internal combustion engine based at least in part on the perception task. The operations further include, responsive to determining to stop the internal combustion engine, stopping the internal combustion engine.

In addition to one or more of the features described herein, or as an alternative, further embodiments of the vehicle may include that the operations further include, responsive to determining that the internal combustion engine of the vehicle is stopped, determining whether to start the internal combustion engine based at least in part on the perception task.

In addition to one or more of the features described herein, or as an alternative, further embodiments of the vehicle may include that the operations further include, responsive to determining to stop the internal combustion engine, starting the internal combustion engine.

In addition to one or more of the features described herein, or as an alternative, further embodiments of the vehicle may include that the sensor is a camera.

In addition to one or more of the features described herein, or as an alternative, further embodiments of the vehicle may include that determining whether to start the internal combustion engine is further based at least in part on data about a start/stop condition of the vehicle, data about an operator input for the vehicle, and data external to the vehicle.

In addition to one or more of the features described herein, or as an alternative, further embodiments of the vehicle may include that the perception task determines an amount of time until it is desired for the vehicle to move, wherein it is determined to stop the internal combustion engine responsive to the amount of time being greater than a threshold.

In another embodiment a computer program product is provided. The computer program product includes a set of one or more computer-readable storage media and program instructions, collectively stored in the set of one or more computer-readable storage media, for causing a processor set to perform computer operations for intelligent automatic start/stop for vehicle engines. The computer operations include receiving data from a sensor of a vehicle. The computer operations further include performing a perception task based at least in part on the data received from the sensor of the vehicle. The computer operations further include determining whether an internal combustion engine of the vehicle is stopped or started. The computer operations further include, responsive to determining that the internal combustion engine of the vehicle is stopped, determining whether to start the internal combustion engine based at least in part on the perception task. The computer operations further include, responsive to determining to start the internal combustion engine, starting the internal combustion engine. The computer operations further include, responsive to determining that the internal combustion engine of the vehicle is started, determining whether to stop the internal combustion engine based at least in part on the perception task. The computer operations further include, responsive to determining to stop the internal combustion engine, stopping the internal combustion engine.

In addition to one or more of the features described herein, or as an alternative, further embodiments of the computer program product may include that the sensor is a camera.

In addition to one or more of the features described herein, or as an alternative, further embodiments of the computer program product may include that the perception task determines an amount of time until it is desired for the vehicle to move, wherein it is determined to start the internal combustion engine responsive to the amount of time being less than a threshold.

In addition to one or more of the features described herein, or as an alternative, further embodiments of the computer program product may include that the perception task determines an amount of time until it is desired for the vehicle to move, wherein it is determined to stop the internal combustion engine responsive to the amount of time being greater than a threshold.

In addition to one or more of the features described herein, or as an alternative, further embodiments of the computer program product may include that determining whether to start the internal combustion engine is further based at least in part on data about a start/stop condition of the vehicle, data about an operator input for the vehicle, and data external to the vehicle, and wherein determining whether to stop the internal combustion engine is further based at least in part on the data about the start/stop condition of the vehicle, the data about the operator input for the vehicle, and the data external to the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A illustrates a vehicle with a processing system, a sensor, and a internal combustion engine according to one or more embodiments;

FIG. 1B illustrates the processing system of FIG. 1A according to one or more embodiments;

FIG. 2 illustrates a block diagram of a system for intelligent automatic start/stop for vehicle engines, such as the internal combustion engine of the vehicle of FIG. 1, according to one or more embodiments;

FIG. 3 illustrates a flow diagram of a method for intelligent automatic start/stop for vehicle engines, such as the internal combustion engine of the vehicle of FIG. 1, according to one or more embodiments;

FIG. 4A illustrates a flow diagram of a method for intelligent automatic start for vehicle engines, such as the internal combustion engine of the vehicle of FIG. 1, according to one or more embodiments;

FIG. 4B illustrates a flow diagram of a method for intelligent automatic stop for vehicle engines, such as the internal combustion engine of the vehicle of FIG. 1, according to one or more embodiments; and

FIG. 5 illustrates a block diagram of a processing system for intelligent automatic start/stop for vehicle engines according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to intelligent automatic start/stop for vehicle engines.

The automotive industry has experienced notable progress in vehicle technologies focused on enhancing fuel efficiency and decreasing emissions. One such technology is the automatic start/stop system, which is engineered to shut off the vehicle's engine when the vehicle is stationary and restart the engine when the vehicle is prepared to move again. This system aims to conserve fuel and lower emissions by reducing engine idling time. Nonetheless, despite the potential advantages, the automatic start/stop system has encountered criticism and dissatisfaction from users.

One issue with existing automatic start/stop systems is the perceived delay or lag when restarting the engine, particularly at traffic lights or stop signs. This delay can be frustrating for drivers who anticipate a seamless transition from a stopped to a moving state. Additionally, frequent engine restarts can lead to increased wear and tear on the vehicle's starter and battery, raising concerns about the long-term durability and maintenance costs associated with these components. Furthermore, the engine shutting down in certain situations, such as during parking maneuvers or in traffic jams, can be disconcerting for drivers and may lead to discomfort, irritation, unintended driving delays, or other concerns.

Moreover, existing automatic start/stop systems often lack the ability to adapt to varying driving conditions and may not account for specific scenarios where engine shutdowns are undesirable or hazardous. For instance, stopping in the middle of an intersection, during lane changes, entering roundabouts, or near/on train tracks can pose safety risks if the engine shuts off unexpectedly. These limitations have led some drivers to disable the feature entirely, either manually at the start of each drive or through aftermarket solutions, thereby negating the intended benefits of fuel savings and emission reductions.

One or more embodiments described herein address these and other shortcomings by introducing an intelligent automatic start/stop approach that utilizes advanced perception technologies and machine learning algorithms. One or more embodiments predicts the vehicle's movement needs and makes informed decisions about engine operation based on real-time data from various sensors. By integrating data from onboard vehicle perception modules, external sensors, and driver inputs, one or more embodiments can anticipate when the vehicle will need to move and proactively manage engine start/stop operations. Such one or more embodiments reduce unnecessary engine shutdowns and restarts, improve energy efficiency, improve vehicle functionality, and enhance the overall driving experience by minimizing delays and unanticipated engine behavior.

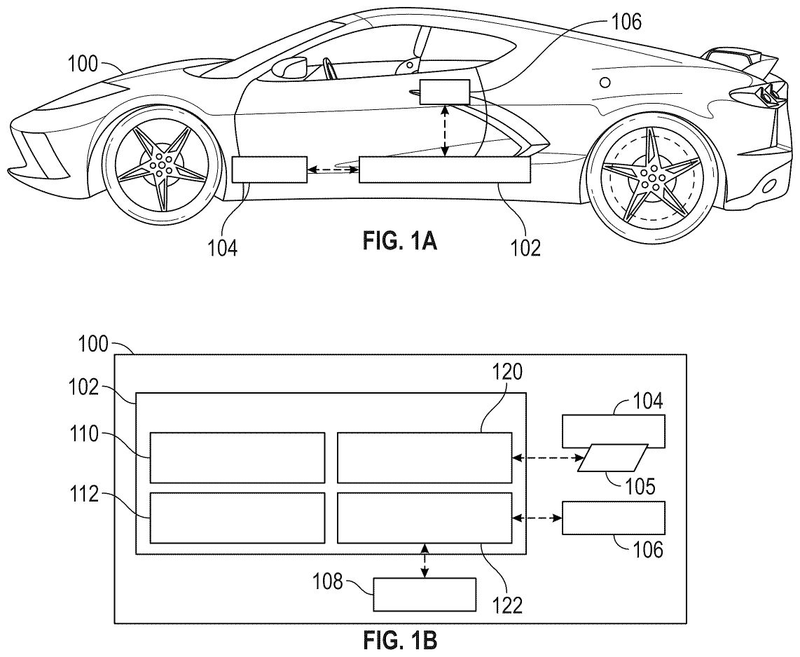

FIG. 1A shows a vehicle 100 with a processing system 102, sensors 104, and an internal combustion engine (ICE) 106 according to one or more embodiments. The vehicle 100 can be a car, a truck, a van, a bus, a motorcycle, a boat, or any other type of automobile. The ICE 106 provides electrical and/or mechanical energy for providing propulsion to the vehicle 100. According to an embodiment, the vehicle 100 is a hybrid electric vehicle, such as a plug-in hybrid electric vehicle (PHEV) partially powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data collected by the sensors 104. The sensors 104 represents one or more sensors, which may vary in type. The sensors 104 may be any suitable sensor(s) and/or combination of sensors, such as a camera, a radar device, a lidar device, a proximity sensor, and/or the like, including combinations and/or multiples thereof. The arrows between the sensors 104 and the processing system 102 indicate the flow of data from the sensors 104 to the processing system 102, highlighting the interaction between these components. This setup enables the vehicle 100 to perform perception tasks, which can be used for autonomous driving for example, using the data collected by the sensors 104. This setup also enables the vehicle 100 to selectively start and stop the ICE 106 based on detected conditions of the vehicle 100 based on information received from the sensors 104 and/or other sources.

Further features and functions of the processing system 102, the sensors 104, and the ICE 106 are now described with reference to FIG. 1B.

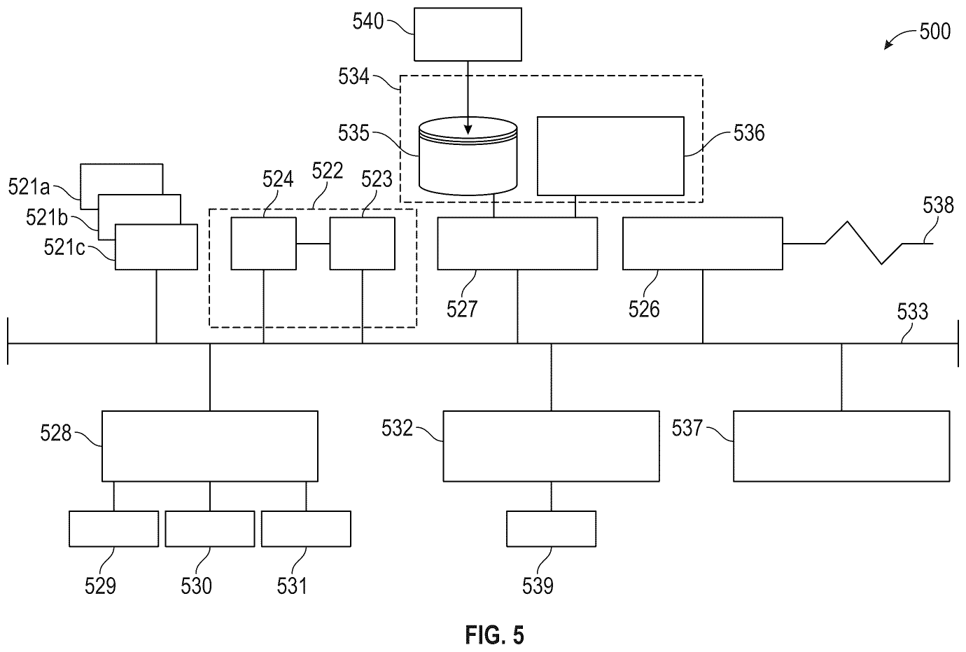

Particularly, FIG. 1B illustrates the processing system 102 of FIG. 1A according to one or more embodiments. According to one or more embodiments, the processing system 102 includes a processing device 110, a memory 112, a perception engine 120, and auto start/stop control engine 122. The processing system 100 is an example of a “controller” as described herein. It should be appreciated that the processing system 102 can be any device suitable for intelligent automatic start/stop for vehicle engines, such as the ICE 106. For example, the processing system 102 can be a device implemented in or otherwise associated with the vehicle 100, such as an electronic control unit (ECU) (also referred to as an electronic control module). As another example, the processing system 102 can be a smartphone, tablet computer, laptop computer, desktop computer, wearable computing device, and/or the like, including combinations and/or multiples thereof. According to one or more embodiments, the features and functionality of the perception engine 120 and/or the auto start/stop control engine 122 can be implemented as processor-executable instructions (e.g., instructions executable by the processing device 110) stored on a computer readable storage medium (e.g., the memory 112). As yet another example, the processing system 102 can be the processing system 500 of FIG. 5 and/or can include one or more components of the processing system 500 of FIG. 5.

The processing device 110 is responsible for executing instructions and managing the overall operation of the processing system 102. The processing device 110 can be any suitable processing circuitry for executing instructions and processing data. For example, the processing device 110 can be a microcontroller, microprocessor, application-specific integrated circuit (ASIC), or any other type of processing unit capable of handling the computational demands of the processing system 102. The processing device 110 is an example of one or more of the processing devices 521 of FIG. 5, as described in more detail herein.

The memory 112 stores data (e.g., data 105), computer-readable instructions, and algorithms useful for operation of the processing system 102. This may include real-time data processing, historical data analysis, and storage of firmware or software programs. The memory 112 is any suitable device for storing data, such as the data 105 received from the sensors 104, and/or instructions. For example, the memory 112 can be a combination of volatile memory (e.g., random access memory) and non-volatile memory (e.g., read-only memory, flash memory). The memory 112 is an example of one or more of the system memory 522, the random access memory 523, and/or the read-only memory 524 of FIG. 5, as described in more detail herein.

The processing system 102 receives data 105 (from the sensors 104) about the vehicle 100 (e.g., telemetry data about the vehicle) and/or about the environment in which the vehicle is operating (e.g., images of objects in the environment, point cloud data of objects in the environment, etc.). According to one or more embodiments, the data 105 can include one or more of images of traffic signs, images of traffic lights, images of nearby vehicles, images of road features (e.g., roundabouts, interchanges, etc.), and/or the like, including combinations and/or multiples thereof. According to one or more embodiments, the data 105 can be images of a lane in which the vehicle 100 is traveling, including any lane markers (e.g., lane lines, turn indicators, etc.) of the lane. The data 105 can be useful, for example, for performing perception tasks, which in turn are used to control the vehicle (e.g., to selectively start or stop the ICE 106).

The perception engine 120 is responsible for processing data (e.g., data 105) received from various sensors (e.g., the sensors 104), such as cameras, radar devices, and lidar devices, to perform perception tasks including object detection, classification, tracking, lane detection, road sign recognition, and obstacle avoidance. By analyzing this sensor data, the perception engine 120 can generate real-time situational awareness of the environment in which the vehicle 100 operates.

The auto start/stop control engine 122 is responsible for managing the automatic start/stop functionality of the ICE 106. The auto start/stop control engine 122 engine processes data from the perception engine 120 and other sources to determine whether the ICE 106 should be started or stopped based on current conditions, which in turn are based at least in part on perception tasks performed by the perception engine 120.

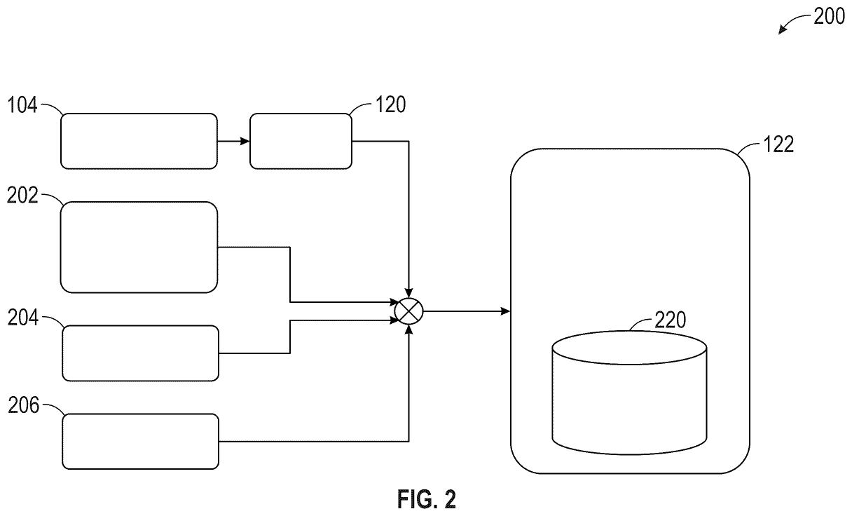

The auto start/stop control engine 122 utilizes an intelligent auto start/stop model, depicted as intelligent auto start/stop model 220 in FIG. 2, to enhance the decision-making process for starting and stopping the ICE 106. The intelligent auto start/stop model 220 integrates data from various sources, including the perception engine 120, which processes sensor data to provide real-time situational awareness. The intelligent auto start/stop model 220 leverages this data to predict whether the vehicle 100 will need to move shortly (e.g., within a threshold amount of time) if stopped or will be coming to a stop shortly (e.g., within a threshold amount of time) if in motion and determines the optimal times to start or stop the engine. By doing so, the intelligent auto start/stop model 220 aims to reduce unnecessary engine shutdowns and restarts, thereby improving fuel efficiency and reducing wear on the starter and battery (not shown) of the vehicle 100. The intelligent auto start/stop model 220 can also adapt to different driving conditions and learn from actual driving data to refine its predictions over time. This approach helps address common issues associated with traditional auto start/stop systems, such as perceived delays and unexpected engine shutdowns, by making more informed and context-aware decisions.

The auto start/stop control engine 122 can generate an alert or other indication of a status of the ICE 106 (e.g., started or stopped) on a display 108 of the vehicle 100. For example, when the auto start/stop control engine 122 initiates starting the ICE 106, the display 108 can indicate to an operator of the vehicle 100 that the ICE 106 is about to start or has just started. Similarly, when the auto start/stop control engine 122 initiates stopping the ICE 106, the display 108 can indicate to an operator of the vehicle 100 that the ICE 106 is about to stop or has just stopped. The display 108 can be any suitable device or screen for displaying information, images, data, interfaces of applications, and/or the like, including combinations and/or multiples thereof. According to one or more embodiments, the display 108 is a light-emitting diode (LED) display, liquid crystal display (LCD) display, organic light-emitting diode (OLED) display, active-matrix organic light-emitting diode (AMOLED) display, micro light-emitting diode (MicroLED) display, heads up display (HUD), projection display, and/or the like, including combinations and/or multiples thereof.

FIG. 2 illustrates a block diagram of a system 200 designed for intelligent automatic start/stop functionality in vehicle engines according to one or more embodiments. The system 200 includes several interconnected components that work together to optimize the start/stop process, thereby enhancing vehicle performance and efficiency.

The sensors 104 are responsible for collecting various data from the vehicle's surroundings. These sensors can include cameras, radar devices, lidar devices, and other types of sensors that provide comprehensive environmental data. According to one or more embodiments, the perception engine 120 can also receive or otherwise utilize coordinate data from a global positioning system (GPS), map data from a map data repository, and/or the like, including combinations and/or multiples thereof. The perception engine 120 processes this data to perform perception tasks, such as object detection, classification, tracking, lane detection, and road sign recognition. The perception engine 120 can generate processed outputs, such a change to traffic lights (e.g., red to green), traffic signs (e.g., yield sign, stop sign), lane indicators, vehicle position/orientation, and/or the like, including combinations and/or multiples thereof). This processing is useful for generating real-time situational awareness, which is in turn used for making informed decisions about engine operation (e.g., start/stop decisions).

The system 200 also incorporates auto start/stop related vehicle variables 202, which provide insights into the current operational state of the vehicle 100, such as speed, engine status, and other relevant metrics.

The system 200 also considers driver input 204. The driver input 204 (e.g., brake pedal pressure, accelerator pedal pressure, steering inputs, and/or the like, including combinations and/or multiples thereof) identifies real-time actions taken by the driver (or “operator”) of the vehicle 100, such as applying brake pedal pressure and steering inputs, which can influence the decision to start or stop the engine.

External sensors 206 contribute additional data from outside the vehicle 100, referred to as external data. The external data can include, for example, traffic conditions, construction information, weather information, and other environmental factors that might affect driving conditions. The external data can be received from sensors of other vehicles, infrastructure devices (e.g., traffic cameras), and/or the like, including combinations and/or multiples thereof. The external data is useful for providing a holistic view of the vehicle's operating environment.

The data from the sensors 104, the auto start/stop related vehicle variables 202, the driver input 204, and the external data from the external sensors 206 can be fed into the auto start/stop control engine 122. The auto start/stop control engine 122 utilizes the intelligent auto start/stop model 220, which is designed to integrate and analyze the aggregated data to make precise and context-aware decisions about when to start or stop the ICE 106. The auto start/stop control engine 122 aims to reduce unnecessary engine shutdowns and restarts, thereby improving fuel efficiency and reducing wear on the vehicle's starter and battery.

According to one or more embodiments, the auto start/stop control engine 122 is a machine learning model. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”), which may be the auto start/stop control engine 122 can be used for determining when to automatically start or stop ICE 106, for example.

In one or more embodiments, machine learning functionality can be implemented using an artificial neural network (ANN) having the capability to be trained to perform a function. In machine learning and cognitive science, ANNs are a family of statistical learning models inspired by the biological neural networks in nature. ANNs can be used to estimate or approximate systems and functions that depend on a large number of inputs. Convolutional neural networks (CNN) are a class of deep, feed-forward ANNs that are particularly useful at tasks such as, but not limited to, analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. In the context of the present disclosure, the auto start/stop control engine 122 may be implemented using an RNN architecture or another similar architecture that is efficient at processing time series data, that is data with a temporal aspect. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for engine start/stop determination is defined by a set of input neurons that can be activated by data from the data from the sensors 104, the auto start/stop related vehicle variables 202, the driver input 204, and the external data from the external sensors 206. After being weighted and transformed by a function determined by the network's designer, the activation of these input neurons are then passed to other downstream neurons, which are often referred to as “hidden” neurons. This process is repeated until an output neuron is activated. The activated output neuron is a prediction of whether to start or stop ICE 106.

The intelligent model is adaptive, meaning it can learn from actual driving data and adjust its predictions over time to better suit different driving conditions. This adaptability helps address common issues associated with traditional auto start/stop systems, such as perceived delays and unexpected engine shutdowns. By making more informed and context-aware decisions, the system 200 enhances the overall driving experience, ensuring that the ICE 106 operates only when necessary while also reducing unwanted effects (. e.g., delays in starting), thus optimizing fuel consumption and reducing emissions while improving vehicle responsiveness.

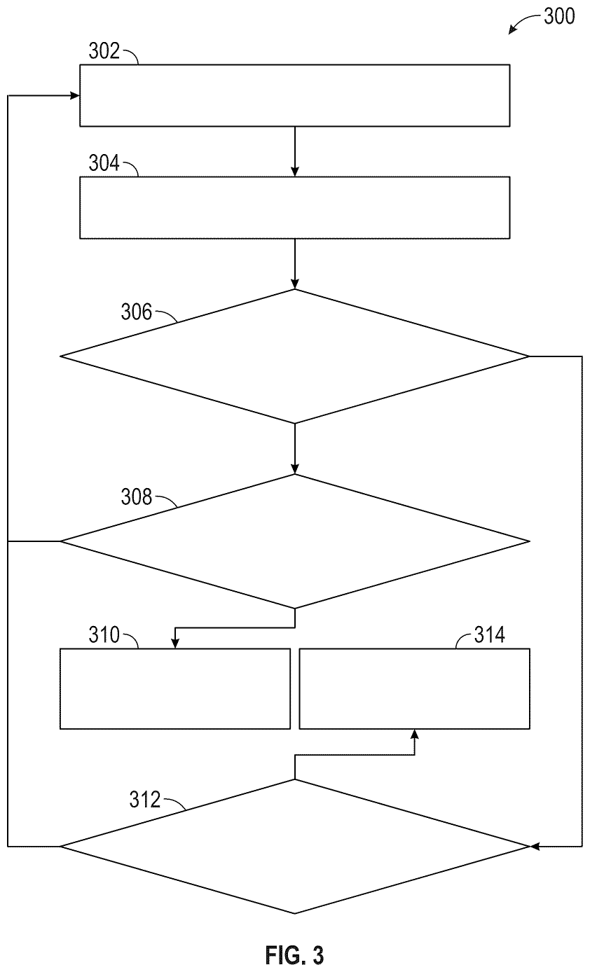

FIG. 3 illustrates a flow diagram of a method 300 for intelligent automatic start/stop for vehicle engines, such as the ICE 106 of the vehicle 100, according to one or more embodiments. The method 300 can be implemented using any suitable system or device. For example, the method 300, and its operations, can be implemented using the processing system 102 of FIGS. 1A and 1B, by the processing system 500 of FIG. 5, and/or the like, including combinations and/or multiples thereof. The method 300 provides for efficient and reliable operation of the vehicle 100 by intelligently starting/stopping the ICE 106. The method 300 is now described with reference to at least portions of FIGS. 1A, 1B, and 2 but is not so limited.

The method 300 begins with operation 302, where data is received from a sensor (e.g., sensors 104) of a vehicle (e.g., the vehicle 100). This data can originate from various types of sensors, such as cameras, radar, or lidar devices, which are responsible for capturing information about the surroundings and operational state of the vehicle 100. The data collected is useful for enabling the vehicle's systems to understand the current environment and make informed decisions regarding engine operation.

In operation 304, the processing system 102, using the perception engine 120, performs a perception task based on the data received from the sensor. This involves processing the sensor data to identify and interpret relevant features of the environment, such as detecting objects, recognizing road signs, or identifying lane markings. The perception task is useful for generating situational awareness, allowing the vehicle 100 to assess its surroundings accurately and respond appropriately.

Operation 306 involves determining whether the ICE 106 of the vehicle 100 is currently started or stopped. This decision is based on the analysis of information/data received from components or systems of the engine. For example, an engine control unit (not shown) associated with the ICE 106 can send a signal to the processing system 102 indicating whether the ICE 106 is started or stopped. Understanding the status of the ICE 106 is useful in managing the start/stop functionality, as it dictates the subsequent actions the processing system 102 will take to optimize performance and efficiency of the ICE 106.

Responsive to determining that the ICE 106 is stopped (operation 306 “No”), the method 300 proceeds to operation 308. In operation 308, the processing system 102, using the auto start/stop control engine 122, determines whether to start the ICE 106 based at least in part on the perception task. If the engine is currently stopped, the auto start/stop control engine 122 evaluates the situational data to decide if starting the ICE 106 would be beneficial. This decision is influenced by factors such as the vehicle's predicted movement needs, traffic conditions, and driver inputs, ensuring that the engine is only started when required.

If it is determined to start the ICE 106 (operation 308 “Yes”), the method 300 proceeds to operation 310, where the ICE 106 is started. This operation is executed promptly to minimize any delay in vehicle operation, thereby enhancing the driving experience and vehicle functionality. Otherwise, the method 300 returns to block 302 and continues.

Responsive to determining that the ICE 106 is started (operation 306 “Yes”), the method 300 proceeds to operation 312. At operation 312, the processing system 102 determines whether to stop the ICE 106 based on the perception task and other data inputs. If stopping the ICE 106 would be beneficial, the processing system 102 causes the ICE 106 to stop to conserve fuel and reduce emissions at operation 314. Otherwise, the method 300 returns to block 302 and continues. According to one or more embodiments, the processing system 102 can learn from driver's actions and improve its predictions accordingly. This decision-making process is dynamic and adapts to changing driving conditions, ensuring that the ICE 106 operates only when desired while reducing delay in starting the ICE 106 when desired.

Additional processes also may be included, and it should be understood that the processes depicted in FIG. 3 represent illustrations, and that other processes may be added, or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 102 of FIGS. 1A and 1B, the processing system 500 of FIG. 5, and/or the like, including combinations and/or multiples thereof), cause the processor to perform the processes described herein.

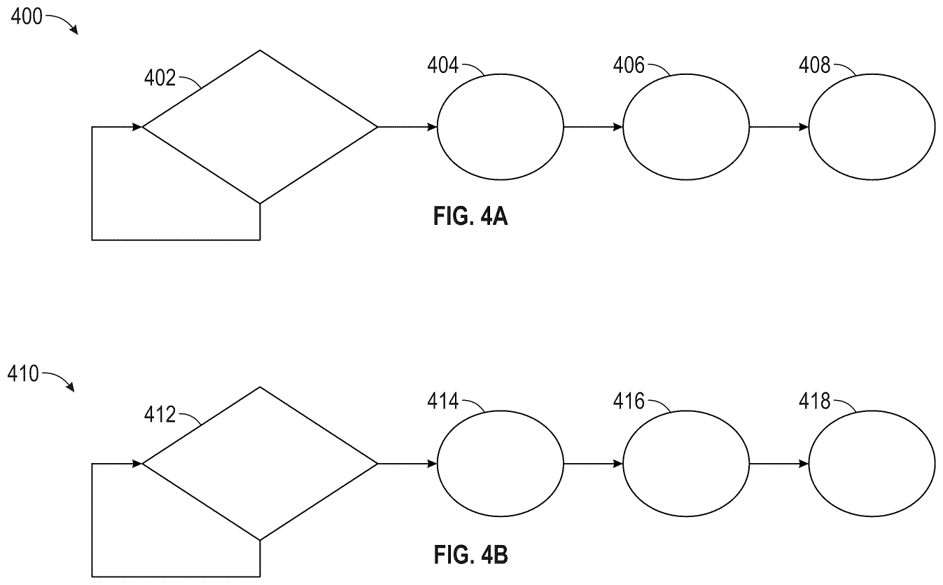

FIG. 4A illustrates a flow diagram of a method 400 for the intelligent automatic start of vehicle engines, such as the ICE 106, according to one or more embodiments. The method 400 begins with operation 402, where the processing system 102 evaluates whether the vehicle 100, being stopped, will need to move within a specified time frame, a threshold denoted as “X” seconds, where X is a positive number. This decision is based on data from various sensors and perception tasks that assess the vehicle's surroundings and operational state as described herein. If the processing system 102 predicts that the vehicle 100 will need to move soon (e.g., within X seconds, or some other threshold), the method 400 proceeds to operation 404. In operation 404, the processing system 102 initiates the auto-start of the engine (e.g., the ICE 106). This action is taken to ensure that the vehicle 100 is ready to move without delay, even before an operator/driver of the vehicle may recognize the need to move, enhancing the driving experience by minimizing any perceived lag. According to one or more embodiments, following the engine start, operation 406 involves displaying an alert to the driver, such as on the display 108 of the vehicle 100. This alert informs the driver that the engine (e.g., the ICE 106) is about to start or has just started, providing real-time feedback on the vehicle's status. It should be understood that the alert in operation 406 may be omitted or bypassed in various embodiments. Finally, operation 408 completes the method 400 by confirming the auto-start of the engine (e.g., the ICE 106), ensuring that the vehicle 100 is prepared for movement.

FIG. 4B presents a flow diagram of a method 410 for the intelligent automatic stop of vehicle engines, such as the ICE 106, according to one or more embodiments. The method 410 begins with operation 412, where the processing system 102 assesses whether the vehicle 100 will need to remain stationary for a specified duration, a threshold denoted as “Y” seconds. This evaluation is based on sensor data and perception tasks that provide insights into the vehicle's environment and operational conditions as described herein. If the processing system 102 determines that the vehicle 100 can remain stationary, the method 410 proceeds to operation 414. In operation 414, the processing system 102 initiates shutdown of the engine (e.g., the ICE 106). Following the decision to shut down the engine (e.g., the ICE 106), operation 416 involves displaying an alert to the driver. This alert notifies the driver that the engine (e.g., the ICE 106) is about to stop or has just stopped, thereby alerting the driver of the vehicle's status. Finally, operation 418 completes the method 410 by causing the auto-stop of the engine (e.g., the ICE 106), conserving fuel and reducing emissions by avoiding unnecessary idling.

One or more embodiments described herein can be implemented for various use cases. For example, the intelligent automatic start/stop approach described herein is designed to handle specialized cases, enhancing the vehicle's responsiveness and efficiency. One or more embodiments are capable of managing scenarios, such as changes in traffic lights, where the system can anticipate the need to start the engine as the light turns green. One or more embodiments also addresses situations where a leading vehicle starts moving or is about to move, detected through brake lights, ensuring the engine is ready to respond promptly. One or more embodiments is adept at handling stops at stop or yield signs, crossing lanes, parking, and during lane switches, as well as navigating roundabouts and intersections. One or more embodiments also considers the safety of stopping near, at, or on train tracks and before making a turn. By reducing unnecessary engine shutdowns and restarts, one or more embodiments significantly improve energy efficiency, making them applicable to both internal combustion engines and hybrid vehicles. Such approaches not only conserve fuel and reduces emissions but also minimizes wear on vehicle components, contributing to a more sustainable and cost-effective driving experience.

One or more embodiments offer significant technical benefits. For example, one or more embodiments described herein offer significant benefits in terms of vehicle functioning. For example, one or more embodiments described herein improves fuel efficiency. By intelligently managing the start and stop operations of the internal combustion engine, one or more embodiments reduces unnecessary idling, which in turn conserves fuel and lowers emissions. This not only contributes to environmental sustainability but also results in cost savings for the vehicle owner.

Another technical benefit is the reduction of wear and tear on the vehicle's components, particularly the starter and battery. Traditional start/stop systems can lead to increased wear due to frequent engine restarts. However, the intelligent model used in these embodiments minimizes unnecessary engine operations (unnecessary start/stop cycles), thereby extending the lifespan of these components and reducing maintenance.

One or more embodiments also improves the overall driving and operating experience of the vehicle by addressing common issues associated with traditional auto start/stop systems, such as perceived delays and unexpected engine shutdowns. By making more informed and context-aware decisions, one or more embodiments ensures that the engine operates only when necessary, thus optimizing vehicle responsiveness and enhancing driver comfort.

Additionally, the adaptability of the intelligent model (e.g., the intelligent auto start/stop model 220) allows it to learn from actual driving data and adjust its predictions over time. This continuous learning capability enables the model to better suit different driving conditions, further improving its efficiency and effectiveness.

Overall, these technical benefits and improvements contribute to a more reliable, efficient, and user-friendly vehicle operation.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s) 521). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit. According to one or more embodiments, the user interface adapter 528 can include one or more of a touch screen, pedals pressure, and steering wheel use, among others.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 525 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for intelligent automatic start/stop for vehicle engines, the method comprising:
receiving data from a sensor of a vehicle;
performing a perception task based at least in part on the data received from the sensor of the vehicle;
determining whether an internal combustion engine of the vehicle is stopped or started;
responsive to determining that the internal combustion engine of the vehicle is stopped, determining whether to start the internal combustion engine based at least in part on the perception task; and
responsive to determining to start the internal combustion engine, starting the internal combustion engine.

2. The computer-implemented method of claim 1, further comprising, responsive to determining that the internal combustion engine of the vehicle is started, determining whether to stop the internal combustion engine based at least in part on the perception task.

3. The computer-implemented method of claim 2, further comprising, responsive to determining to stop the internal combustion engine, stopping the internal combustion engine.

4. The computer-implemented method of claim 1, wherein the sensor is a camera.

5. The computer-implemented method of claim 1, wherein determining whether to start the internal combustion engine is further based at least in part on data about a start/stop condition of the vehicle.

6. The computer-implemented method of claim 1, wherein determining whether to start the internal combustion engine is further based at least in part on data about an operator input for the vehicle.

7. The computer-implemented method of claim 1, wherein determining whether to start the internal combustion engine is further based at least in part on data external to the vehicle.

8. The computer-implemented method of claim 1, wherein the perception task detects at least one of: a traffic light change, a traffic sign, a road lane, and an ego position of the vehicle.

9. The computer-implemented method of claim 1, wherein the perception task determines an amount of time until it is desired for the vehicle to move, wherein it is determined to start the internal combustion engine responsive to the amount of time being less than a threshold.

10. A vehicle comprising:
a sensor;
an internal combustion engine; and
a processing system comprising:
a memory comprising computer readable instructions; and
a processing device for executing the computer readable instructions, the computer readable instructions controlling the processing system to perform operations for intelligent automatic start/stop for vehicle engines, the operations comprising:
receiving data from the sensor;
performing a perception task based at least in part on the data received from the sensor of the vehicle;
determining whether the internal combustion engine of the vehicle is stopped or started;
responsive to determining that the internal combustion engine of the vehicle is started, determining whether to stop the internal combustion engine based at least in part on the perception task; and
responsive to determining to stop the internal combustion engine, stopping the internal combustion engine.

11. The vehicle of claim 10, wherein the operations further comprise, responsive to determining that the internal combustion engine of the vehicle is stopped, determining whether to start the internal combustion engine based at least in part on the perception task.

12. The vehicle of claim 11, wherein the operations further comprise, responsive to determining to stop the internal combustion engine, starting the internal combustion engine.

13. The vehicle of claim 11, wherein the sensor is a camera.

14. The vehicle of claim 11, wherein determining whether to start the internal combustion engine is further based at least in part on data about a start/stop condition of the vehicle, data about an operator input for the vehicle, and data external to the vehicle.

15. The vehicle of claim 11, wherein the perception task determines an amount of time until it is desired for the vehicle to move, wherein it is determined to stop the internal combustion engine responsive to the amount of time being greater than a threshold.

16. A computer program product comprising:
a set of one or more computer-readable storage media;
program instructions, collectively stored in the set of one or more computer-readable storage media, for causing a processor set to perform computer operations for intelligent automatic start/stop for vehicle engines, the computer operations comprising:
receiving data from a sensor of a vehicle;
performing a perception task based at least in part on the data received from the sensor of the vehicle;
determining whether an internal combustion engine of the vehicle is stopped or started;
responsive to determining that the internal combustion engine of the vehicle is stopped, determining whether to start the internal combustion engine based at least in part on the perception task;
responsive to determining to start the internal combustion engine, starting the internal combustion engine;
responsive to determining that the internal combustion engine of the vehicle is started, determining whether to stop the internal combustion engine based at least in part on the perception task; and
responsive to determining to stop the internal combustion engine, stopping the internal combustion engine.

17. The computer program product of claim 16, wherein the sensor is a camera.

18. The computer program product of claim 16, wherein the perception task determines an amount of time until it is desired for the vehicle to move, wherein it is determined to start the internal combustion engine responsive to the amount of time being less than a threshold.

19. The computer program product of claim 16, wherein the perception task determines an amount of time until it is desired for the vehicle to move, wherein it is determined to stop the internal combustion engine responsive to the amount of time being greater than a threshold.

20. The computer program product of claim 16, wherein determining whether to start the internal combustion engine is further based at least in part on data about a start/stop condition of the vehicle, data about an operator input for the vehicle, and data external to the vehicle, and wherein determining whether to stop the internal combustion engine is further based at least in part on the data about the start/stop condition of the vehicle, the data about the operator input for the vehicle, and the data external to the vehicle.
